(19) United States
(12) Patent Application Publication
(10) Pub. No.: US 2007/0241487 A1
(43) Pub. Date: Oct. 18, 2007

(54) Method for Controlling the Quantity of Air in a Self-Contained Air Supply System for a Chassis

(75) Inventors: Heike Ilias, Wedemark (DE); Uwe Folchert, Lauenau (DE)

Correspondence Address: CONTINENTAL TEVES, INC., ONE CONTINENTAL DRIVE, AUBURN HILLLS, MI, 48326-1581, US

(73) Assignee: Continental Aktiengesellschaft

(21) Appl. No.: 11/579,434

(22) PCT Filed: Mar. 7, 2005
(86) PCT No.: PCT/EP05/51011

§ 371 Date: Nov. 3, 2006

(30) Foreign Application Priority Data
May 3, 2004 (DE) 10 2004 021 593.6

(51) Int. Cl. B60G 11/27

(52) U.S. Cl. 267/64.28

(57) ABSTRACT

The object of the invention is to simplify the method for controlling the air volume in a closed air supply installation. To this end, the pressure of the pneumatic springs (3, 4) is first determined when air is let out of the pneumatic springs (3, 4) into a defined control chamber, the average volume flow of a defined controlling process between the air chamber (5) and the pneumatic springs (3, 4) is determined, and the pressure in the air chamber (5) is calculated from a functional dependency in relation to the determined pressure in the pneumatic springs (3, 4), the determined average volume flow and the measured external temperature. The pressurised air volume of the air supply installation is then calculated from the calculated or determined pressures, the known or determined volumes of the air chamber (5) and the pneumatic springs (3, 4), and compared with an optimum pressurised air volume.

The invention relates to a method according to the preamble of claim 1. Such air supply systems are used, for example, for controlling the ride level of motor vehicles.

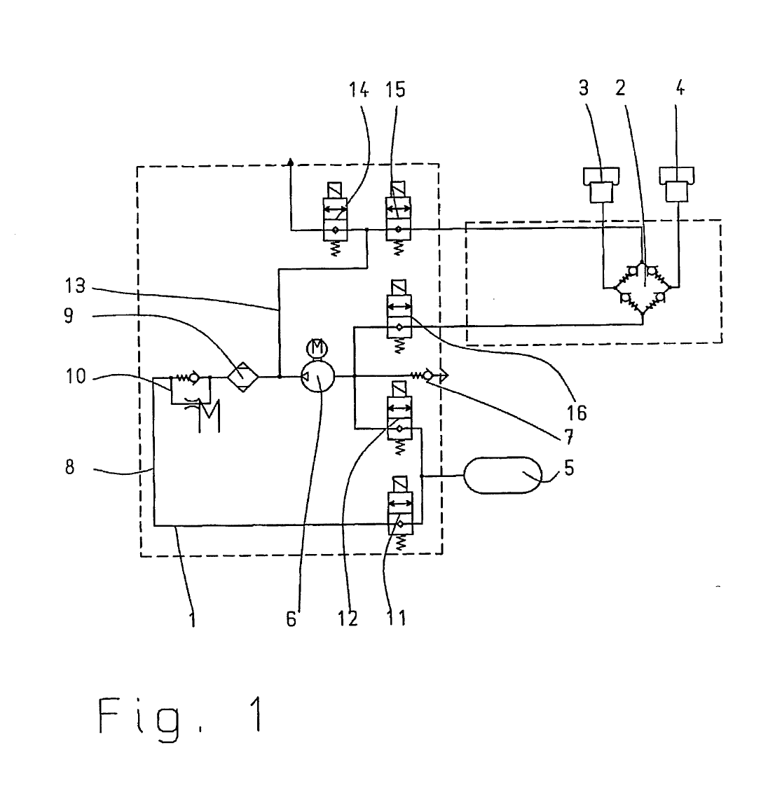

Such an air supply system is known from EP 1 243 447 A2. According to its FIG. 1, this air supply system is composed essentially of an air supply unit and a plurality of air springs for supporting the vehicle body. The air supply unit includes mainly a compressor and an air accumulator. Here, the compressor is connected on the intake side to the atmosphere and on the pressure side to the air accumulator via an air dryer and a first 2/2 way valve. The compressor thus supplies the air accumulator with fresh air from the atmosphere. The compressor is connected to the air springs on the intake side via a second 2/2 way valve. As a result, the compressor transfers compressed air from the air springs into the air accumulator via the first 2/2 way valve. The compressor is also connected on the intake side to the air accumulator via a third 2/2 way valve and on the pressure side to the air springs via a fourth 2/2 way valve. As a result, compressed air is fed into the air springs from the air accumulator.

The air springs are arranged in parallel with one another, a 2/2 way valve being assigned to each air spring and all the 2/2 way valve units being connected to the air supply unit via a connecting line. There is a pressure sensor in the common collecting line of the directional valve unit.

Such self-contained air supply systems operate within a previously defined performance range whose limits are often undershot as a result of the fact that a quantity of compressed air escapes due to a leakage or the limits of said air supply systems are often exceeded as a result of the fact that the quantity of compressed air is increased as a result of a rise in temperature. Within the process of controlling the ride level of the vehicle this has the effects of slowing down the raising of the vehicle body if the quantity of air is too low and of slowing down the layering of the vehicle body if the quantity of compressed air is too high.

In order to ensure that the performance range is in its admissible limits, a sufficient quantity of compressed air must therefore always be present in the air supply system. To do this, the pressure in the air springs and in the air accumulator is continuously measured using the pressure sensor and the excess or the demand for an additional quantity of compressed air is calculated therefrom. When there is an excess, a quantity of compressed air is let out of the air supply system, and when there is demand for a quantity of compressed air the air accumulator is topped up with fresh air.

This known method satisfies the technical requirements. However, the expenditure in terms of equipment is relatively high. As a result, in each of the two cases it is necessary to use a pressure sensor with corresponding cabling. This entails additional costs. Furthermore, the pressure sensor with its cabling requires additional installation space which is generally not present in vehicle equipment and which therefore leads to compromises in the implementation of the air supply system. This also entails higher costs.

DE 101 22 567 C1 discloses a further method for controlling the quantity of air in which the inference of the instantaneous load is excluded from the process of controlling the quantity of air and, as a result, the quantity of air is controlled only when there is deviation from the defined rated band of air quantities which is due to leakage or temperature fluctuation. Here, the instantaneous quantities of compressed air in the air accumulator and in the air springs are determined by measuring the pressures in the air accumulator and in the air springs using a pressure sensor and multiplying them by the known volume of the air accumulator and by the volume of the air springs determined by means of a travel measurement. The quantity of compressed air which is determined in this way for the air supply system is compared with the optimum quantity of compressed air for a design rated load. If the quantity of compressed air which is determined is less than a minimum necessary quantity of compressed air, a specific quantity of compressed air must be added, and if it is greater than a maximum admissible quantity of compressed air, a specific quantity of compressed air must be let out. The time which is necessary for supplying or letting out compressed air is determined from the known characteristic curve for the controlling speed/quantities of compressed air and the corresponding valves or the compressor in the air supply system is activated for this time period.

This method also requires the presence of a pressure sensor with all its disadvantages already described. In addition, this method is relatively complex in terms of software because the actual volume has to be continuously calculated in order to determine the time necessary for the topping up and letting out processes.

The object is therefore to simplify the method of the generic type for controlling the quantity of air in a self-contained air supply system.

This object is achieved by means of the characterizing features of claim 1. Expedient embodiments can be found in the subclaims 2 to 4. The new method eliminates the aforesaid disadvantages of the prior art. Here, the particular advantage of the new method is that there no longer any need for complex pressure measurement in order to determine the quantity of compressed air which is lacking or in excess but rather only the travel and/or the time required for it have to be measured during the raising process and/or lowering process. Such a measurement of travel or time is possible with relatively simple means which are generally part of the technical equipment. This simplifies the technical equipment of the air supply system and reduces the costs necessary for it. This expenditure on equipment can also be reduced further if, for example, the travel is predefined for the movement of the air spring. Then, only the time has to be measured.

The new method for controlling the quantity of air can of course also be applied in other air supply systems.

The new method will be explained in more detail with reference to an exemplary embodiment.

FIG. 1 shows a circuit diagram of a self-contained air supply system.

According to said figure, the air supply system is composed essentially of a drive unit 1, of a nonreturn valve combination 2, of at least two air springs 3, 4 and of an air accumulator 5. The core of the drive unit 1 is a compressor 6 which is driven by an electric motor and which is connected on one side to the atmosphere via an intake valve 7. On the pressure side, the compressor 6 is connected to the air accumulator 5 via an accumulator pressure line 8. In this accumulator pressure line 8 there is an air dryer 9, a throttle nonreturn valve 10 which opens in the direction of the air accumulator 5 and a first pressure-side 2/2 way valve 11. The compressor 6 is also connected on the intake side to the air accumulator 5 via a first intake-side 2/2 way valve 12. On the pressure side the compressor 6 is furthermore connected on one side to the atmosphere via an outlet valve 14 via an actuator pressure line 13 and on the other side to the air springs 3, 4 via a second pressure-side 2/2 way valve 15 and the nonreturn valve combination 2. The compressor 6 is also connected on the intake side to the air springs 3, 4 via a second intake-side 2/2 way valve 16 and the nonreturn valve combination 2. The nonreturn valve combination 2 is embodied in such a way that it forms a connection to the pressure side or to the intake side of the compressor 6 as a function of the direction of movement of the air springs 3, 4.

In order to fill the air accumulator 5 with fresh air from the atmosphere, the two intake side 2/2 way valves 12, 16 and the pressure-side 2/2 way valve 15 as well as the outlet valve 14 are closed and the first pressure-side 2/2 way valve 11 is opened. The compressor 6 sucks in the fresh air from the atmosphere via the intake valve 7 and feeds it to the opening throttle nonreturn valve 10 and the opened first pressure-side 2/2 way valve 11 in the air accumulator 5 via the air dryer 9.

In order to fill the air springs 3, 4 with compressed air from the air accumulator 5, the first pressure-side 2/2 way valve 11, the second intake-side 2/2 way valve 16 and the blow off valve 14 are closed. In contrast, the first intake-side 2/2 way valve 12 and the second pressure-side 2/2 way valve 15 of the compressor 6 are opened so that the compressor 6 sucks in the air from the air accumulator 5 and feeds it to the air springs 3, 4 via the actuator pressure line 13 and the nonreturn valve combination 2.

In order to transfer dry compressed air which is not required from the air springs 3, 4 into the air accumulator 5, the first intake-side 2/2 way valve 12, the second pressure-side 2/2 way valve 15 and the outlet valve 14 are closed and the second intake-side 2/2 way valve 16 and the first pressure-side 2/2 way valve 11 are opened. As a result, the air from the air springs 3, 4 is fed into the air accumulator 5 via the nonreturn combination 2, the compressor 6 and the first pressure-side 2/2 way valve 11. In order to regenerate the dryer 10 with dry compressed air which is not required from the compressed air pressure accumulator 5, the two intake side 2/2 way valves 12, 16 and the second pressure-side 2/2 way valve 15 are closed and the first pressure-side 2/2 way valve 11 and the outlet valve 14 are opened. As a result, air is fed counter to the filling direction from the air accumulator 5 into the atmosphere via the accumulator pressure line 8, the throttle nonreturn valve 10, the air dryer 9, the actuator pressure line 16 and the outlet valve 14.

In order to safeguard all these functions it is necessary for a sufficient quantity of compressed air to be present in the air supply system within a tolerance band for the quantity of air for a design rated vehicle load.

When the design rated quantity of compressed air is undershot outside the tolerance band for the quantity of air, the air supply system has to be topped up with a necessary quantity of compressed air. In contrast, when the design rated quantity of compressed air is exceeded outside the tolerance band for the quantity of air a specific quantity of compressed air has to be let out of the air supply system. In both cases it is ensured that the loaded vehicle body rises or lowers with a toleranced speed.

The new method is applied if the pressure in the air accumulator 5 is higher than the pressure in the air springs 3, 4 and the flow in the throttle nonreturn valve 10 and in the air dryer 9 are in the subcritical range.

At first, a self-controlled control space is selected within the air supply system, the crank casing of the compressor 6 and the air dryer being suitable for this. This control space is placed at a defined pressure level. It is expedient to connect this control space to the atmosphere using the 2/2 way valve 14 so that the atmospheric pressure is set in the control space. This pressure in the control space is thus known. Then, the 2/2 way valve 16 is opened for a defined time so that a quantity of compressed air from the air springs 3, 4 with the higher pressure flows into the control space with the lower pressure until the pressure is equalized. In the process, the travel which is carried out by the air springs 3, 4 is measured. The load state of the vehicle is inferred from this travel. The pressure p_{LF} in the air springs is inferred using this load state and the previously determined lowering of the air springs 3, 4 by means of a simulation.
Next, by means of the relationship:

$$\overline{Q} = \frac{Δ V}{Δ t}$$

the average volume flow Q̅ through the throttle nonreturn valve 10 and the air dryer 9 is determined, it being assumed that the pressure p_{accumulator} in the air accumulator 5 is higher than the pressure p_{LF} For this purpose, the 2/2 way valves 11 and 15 are opened for a defined time Δt so that a quantity of compressed air flows from the air accumulator 5 into the air springs 3, 4 via the air dryer 9. In the process, the travel which is carried out by the air springs 3, 4 is measured and the change ΔV in volume is calculated therefrom. The volume flow Q̅ from the air accumulator 5 to the air springs 3, 4 is thus also known.

With the determined pressure p_{LF} in the air springs 3, 4 and the average volume flow Q̅ as well as with the easily determined external temperature T all the variables are known in order to calculate the pressure p_{accumulator} in the air accumulator 5 using the following relationship:

$$\frac{{p}_{LF}}{{p}_{accumulator}} = {b}_{ges} + \sqrt{{( 1 - {b}_{ges} )}^{2} [ 1 - {( \frac{\overline{Q}}{{C}_{ges} {p}_{N}} )}^{2} \frac{{T}_{N}}{T} ]}$$

the system-specific constants b_{ges} and C_{ges} as well as a normative temperature T_{N} and a normative pressure p_{N} being included in the calculation.

With the pressure p_{accumulator} determined in this way in the air accumulator 5 and the known volume in the air accumulator 5 as well as with the pressure p_{LF} which is determined in the air springs 3, 4 and with the volume of the air springs 3, 4 calculated by means of the travel carried out by the air springs 3, 4, the quantity of compressed air in the air supply system is calculated and compared with the tolerance band for the quantity of compressed air. When the minimum admissible quantity of compressed air is undershot, a corresponding quantity of compressed air is added to the air supply system, while when the maximum admissible quantity of compressed air is exceeded a corresponding quantity of compressed air is let out of the air supply system.

The air supply system thus again contains a quantity of compressed air which is within the tolerance band for the quantity of compressed air for the design rating.

### LIST OF REFERENCE NUMERALS

1 Drive unit
2 Nonreturn valve combination
3 Air spring
4 Air spring
5 Air accumulator
6 Compressor
7 Intake valve
8 Accumulator pressure line
9 Air dryer
10 Throttle nonreturn valve
11 First pressure-side 2/2 way valve
12 First intake-side 2/2 way valve
13 Actuator pressure line
14 Outlet valve
15 Second pressure-side 2/2 way valve
16 Second intake-side 2/2 way valve

1.-5. (canceled)

6. A method for controlling the quantity of air in a self-contained air supply system for a chassis in which a demand for or the excess of a necessary quantity of compressed air in the air supply system is determined for a design rating and is added to air springs of the air supply system or let out of the air springs over a defined time, thereby raising or lowering a vehicle axle, the method comprising the following steps:
determining the pressure p_{LF} of the air springs (3, 4) from the magnitude of the lowering of the vehicle axle when the air flows out of the air springs (3, 4) into a defined control space,
determining an average volume flow Q̅ of a defined raising process between an air accumulator (5) having a known volume and the air springs (3, 4) as a quotient from the change in volume of the air springs (3, 4) at a defined time,
calculating the pressure in the air accumulator (5) p_{accumulator} from a functional dependence on the pressure p_{LF} determined in the air springs (3, 4), the determined average volume flow Q̅ and a measured external temperature T,
calculating the quantity of compressed air in the air supply system from the calculated pressure p_{accumulator} of the air accumulator (5) and the known volume of the air accumulator (5) as well as from the determined pressure p_{LF} of the air springs (3, 4),
determining the volume of the air springs (3, 4) from the travel carried out by the air accumulator (5), and
comparing the volume with an optimum quantity of compressed air.

7. The method as claimed in claim 6, wherein pressure p_{accumulator} of the air accumulator is calculated by means of the relationship
$$\frac{{p}_{LF}}{{p}_{accumulator}} = {b}_{ges} + \sqrt{{( 1 - {b}_{ges} )}^{2} [ 1 - {( \frac{\overline{Q}}{{C}_{ges} {p}_{N}} )}^{2} \frac{{T}_{N}}{T} ]}$$
with system-specific constants b_{ges} and C_{ges} and a normative temperature T_{N} and a normative pressure p_{N} being included in the equation.

8. The method as claimed in claim 7, wherein the defined control space is provided in the form of a crank casing of a compressor (6).

9. The method as claimed in claim 7, wherein the defined control space is provided in the form of an air dryer (9).

10. The method as claimed in claim 7, comprising the step of bringing the pressure in the defined control space to a defined pressure level.

11. The method as claimed in claim 10, wherein the defined pressure level approximately equals atmospheric pressure.

12. The method as claimed in claim 7, comprising the steps of inferring a load state of the vehicle from the lowering of the air springs (3, 4), and subsequently determining the pressure p_{LF} in the air springs (3, 4) for this load state by means of a pneumatic simulation.
